(19) United States
(12) Patent Application Publication
(10) Pub. No.: US 2012/0200791 A1
(43) Pub. Date: Aug. 9, 2012

(54) Method and apparatus for composing 3D photographs

(76) Inventor: Kwok Wah Allen Lo, (US)

(21) Appl. No.: 12/931,564

(22) Filed: Feb. 3, 2011

(51) Int. Cl. G02F 1/1335; G06T 15/00

(52) U.S. Cl. 349/15; 345/419

(57) ABSTRACT

A 3D photographic printer uses a digital display device for displaying two or more images for composing a 3D photograph. The images are displayed at different locations so that these images can be projected onto a 3D print material through a projection lens at different projection angles. With the digital display device, it is possible to electronically locate the images at different locations and shift the images without mechanically moving the display device during the entire 3D photographic composing process. It is also possible that only the print material is mechanically shifted to different locations. The display device and the projection lens can be stationary. The display device can be an LCD, LED or plasma display panel.

### FIELD OF THE INVENTION

The present invention relates generally to 3D photographic printing and, in particular, to an optical method for composing 3D photos.

### BACKGROUND OF THE INVENTION

A lenticular-typed 3D photograph has a lenticular sheet disposed on top of an image sheet. On the image sheet, a plurality of compressed images are formed in an interleaving manner. In the simplest form, the compressed images are composed of two views, a right view and a left view. As shown in FIG. 1, the compressed images of the left view are denoted as LI, and the compressed images of the right view are denoted as RI. When the compressed images are aligned with the lenticules disposed on top of the image sheet, the lenticules separate the left view from the right view. As such, the left eye (LE) of a viewer can only see the left view and the right eye (RE) can only see the right view. If the left view and the right view are the images of a scene taken at two different angles, what the viewer sees from the 3D photo is a three-dimensional picture of the scene.

### SUMMARY OF THE INVENTION

The present invention provides a method and apparatus for composing a 3D photograph from two or more images. According to various embodiments of the present invention, the images are displayed at different locations on a digital image display device so that these images can be projected onto a 3D print material through a projection lens or optical image forming device at different projection angles. As such, it is possible to electronically locate the images at different locations and shift the images without mechanically moving the display device during the entire 3D photographic composing process.

Thus, the first aspect of the present invention is a method for producing a 3D picture. The method comprises:

arranging a digital display device on a first plane;

arranging an optical image forming device or enlarging lens on a second plane spaced from the first plane;

displaying a first image on the digital display device at a first location, such that a projection image of the first image is caused to form on a print material through the optical image forming device at a first projection angle, and

displaying a second image on the digital display device at a second location, such that a projection image of the second image is caused to form on the print material through the optical image forming device at a different second projection angle.

The print material is located on a third plane spaced from the second plane and substantially parallel to the first plane, such that the second plane is located between the first plane and the third plane, and the method further comprises:

shifting the print material on the third plane for changing the first projection angle to the second projection angle.

When more than two images are used to compose the 3D photograph, the method further comprises shifting the print material on the third plane for changing the second projection angle to a different third projection angle; and

displaying a third image on the digital display device at a third location, such that a projection image of the third image is caused to form on the print material through the optical image forming device at the third projection angle.

According to one embodiment of the present invention, the digital display device remains stationary relative to the optical image forming device.

According to one embodiment of the present invention, the optical image forming device comprises one or more lenses.

According to various embodiments of the present invention, the digital display device can be a liquid crystal display, a light-emitting diode panel, a plasma display or any image displaying device configured to receive digital image data and display the image data as images at different locations.

According to various embodiments of the present invention, each of the first image and the second image comprises an alignment point, at least one of the first image and the second image on the digital display device is electronically shifted such that the projection image of the first image and the projection image of the second image are aligned on the print material at the alignment point.

According to one embodiment of the present invention, the print material comprises a plurality of lenticules, each of the lenticules having a lenticule base, and the projection image of the first image is caused to form a first compressed image and the projection image of the second image is caused to form a second compressed image at the lenticular base, each of the first and second compressed images having an image width. When the image width of various compressed images is not sufficient to fill the lenticule base, one or more projection angles can be adjusted in order to extend the image width of one or more compressed images.

According to one embodiment of the present invention, the adjustment of the projection angles can be carried out by electronically shifting the displayed images and mechanically moving the print material.

Alternatively, the adjustment of the projection angles can be carried out by electronically shifting the display images and mechanically moving the enlarging lens. It is also possible to mechanically move both the enlarging lens and the print material in order to adjust the projection angles. Thus, according to the present invention, the adjustment of the projection angles can be achieved by moving one or two of the components consisting of the display device, the projection lens and the print material. The moving of the display device can be avoided by electronically moving the images displayed thereon.

The second aspect of the present invention is a 3D printing system or an apparatus for composing a 3D photograph. The apparatus comprises:

a digital display device located on a first plane;

an optical image forming device located on a second plane spaced from the first plane, wherein the digital display device is configured to display a plurality of images at a plurality of locations on the digital display device such that a projection image of each of said plurality of images is caused to form on a print material through the optical image forming device at a different projection angle; and

a holder configured to hold the print material on a third plane spaced from the second plane and substantially parallel to the first plane such that the second plane is located between the first plane and the third plane, wherein a mechanical shifter arranged to shift the holder on the third plane for changing the projection angle.

The apparatus further comprises a data driver configured to provide to the digital display device digital image data indicative of the plurality of images. The plurality of images can be photographic images of a scene taken at different viewing angles, or one or more computer graphic images, or one or more text images.

The digital display device can be composed of one or more display panels.

The present invention will become apparent upon reading the description taken in conjunction with FIGS. 2A to 13.

### BRIEF DESCRIPTION OF THE DRAWINGS

FIG. 1 shows a typical lenticular-typed 3D picture.

FIGS. 2A to 2C show a 3D photo composing process, according to one embodiment of the present invention.

FIGS. 3A-3C show the compressed images under the lenticules at various composing stages.

FIG. 4 shows the compressed images in relation to the width of the lenticule and the aperture of the enlarging lens.

FIG. 5 shows a 3D photo composing process, according to another embodiment of the present invention.

FIG. 6A shows three images are displayed at three different locations on the display device, according to one embodiment of the present invention.

FIG. 6B shows three images are displayed at three different locations on the display device, according to another embodiment of the present invention.

FIG. 6C shows three images are displayed at three different locations on the display device, according to yet another embodiment of the present invention.

FIG. 6D shows four images are displayed at four different locations on the display device.

FIG. 7A shows a possible misalignment of three displayed images for composing a 3D photo.

FIG. 7B shows the shifting of the displayed images for alignment.

FIG. 8A shows a display device, according to one embodiment of the present invention.

FIG. 8B shows a display device, according to another embodiment of the present invention.

FIG. 9A shows a method for filling the gaps in the compressed images, according to one embodiment of the present invention.

FIG. 9B shows a method for the filling the gaps in the compressed images, according to another embodiment of the present invention.

FIG. 9C shows a method for the filling the gaps in the compressed images, according to yet another embodiment of the present invention.

FIGS. 10A and 10B illustrate a method for filling the gaps in the compressed images, according to yet another embodiment of the present invention.

FIG. 10C illustrates filling the gaps in the compressed images with repeated images.

FIG. 11A shows the tilting of the display device in order to reduce the Moire Effect, according to one embodiment of the present invention.

FIG. 11B shows the tilting of the print material in order to reduce the Moire Effect, according to another embodiment of the present invention.

FIG. 12 shows a different embodiment of the 3D photographic printer, according to the present invention.

FIG. 13 shows various components in the 3D photographic printer, according to one embodiment of the present invention.

### DETAILED DESCRIPTION OF THE INVENTION

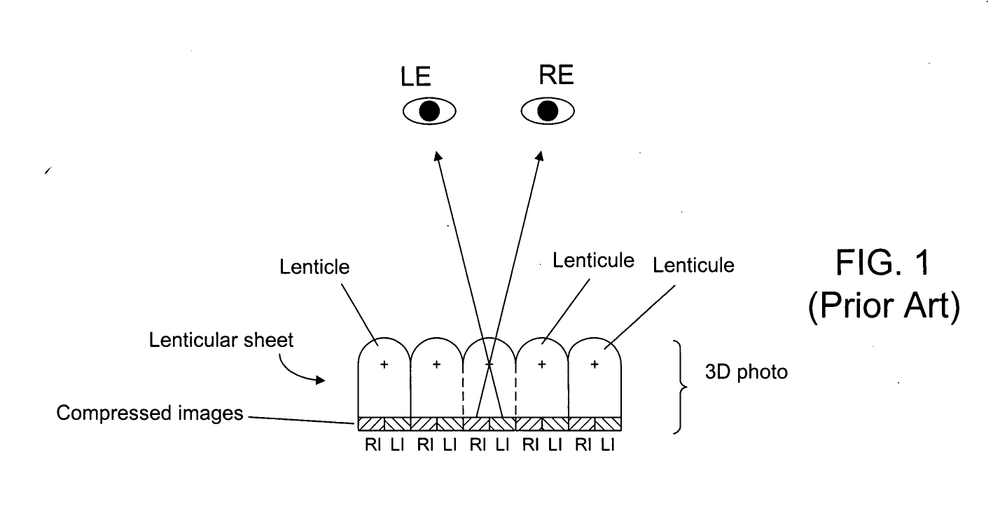

As shown in FIG. 1, in composing a lenticular-typed 3D photo, the photosensitive emulsion under the lenticular screen must be exposed so that the compressed images of different views substantially fill the base of each lenticule. FIG. 1 shows a 3D photo wherein the compressed images of two views are used to fill the entire base of the lenticules. In general, a 3D photo can be composed of the compressed images of two, three, four or more different views. Depending on the optical resolution of a 3D photo, tens or hundreds of different views can be presented in the form of compressed images.

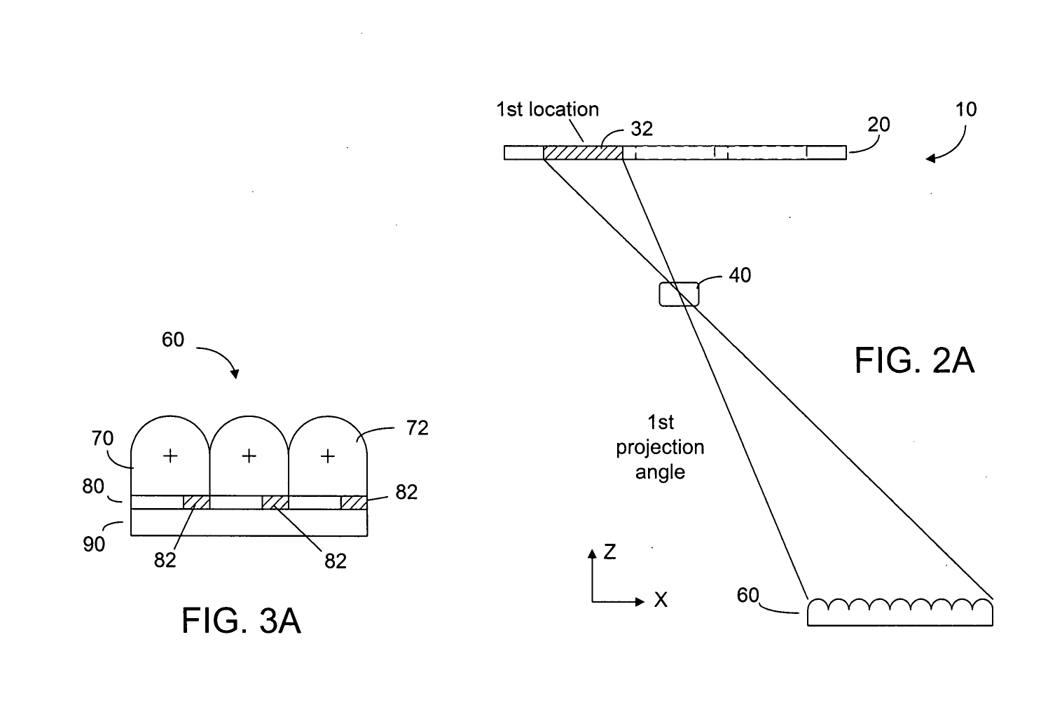

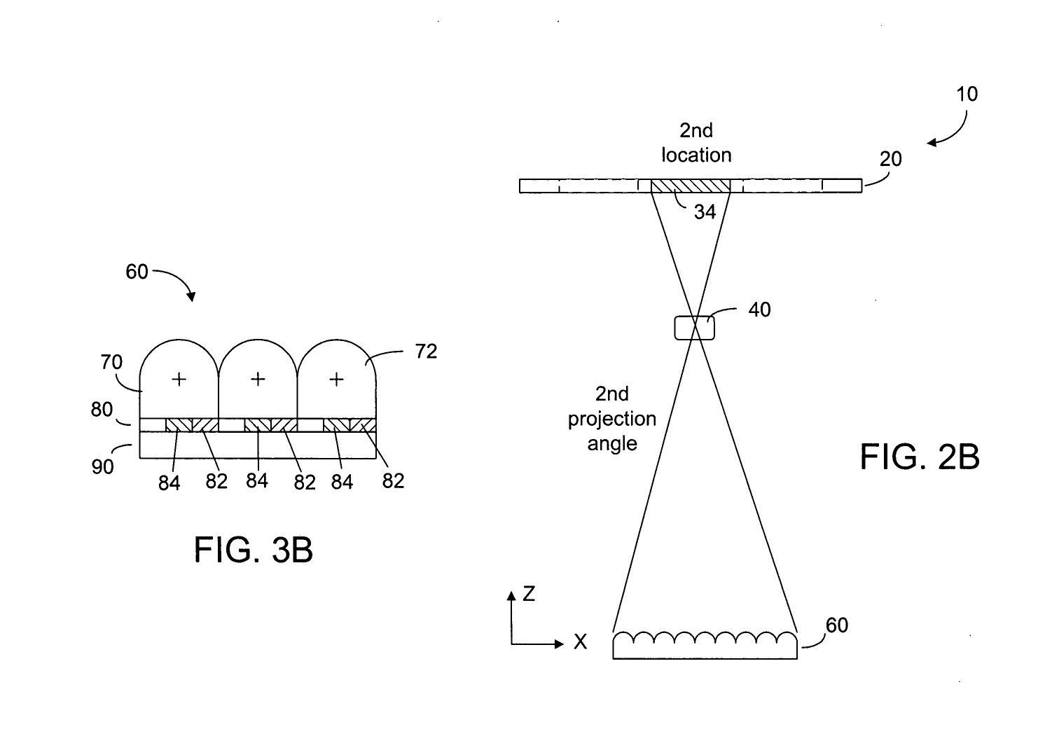

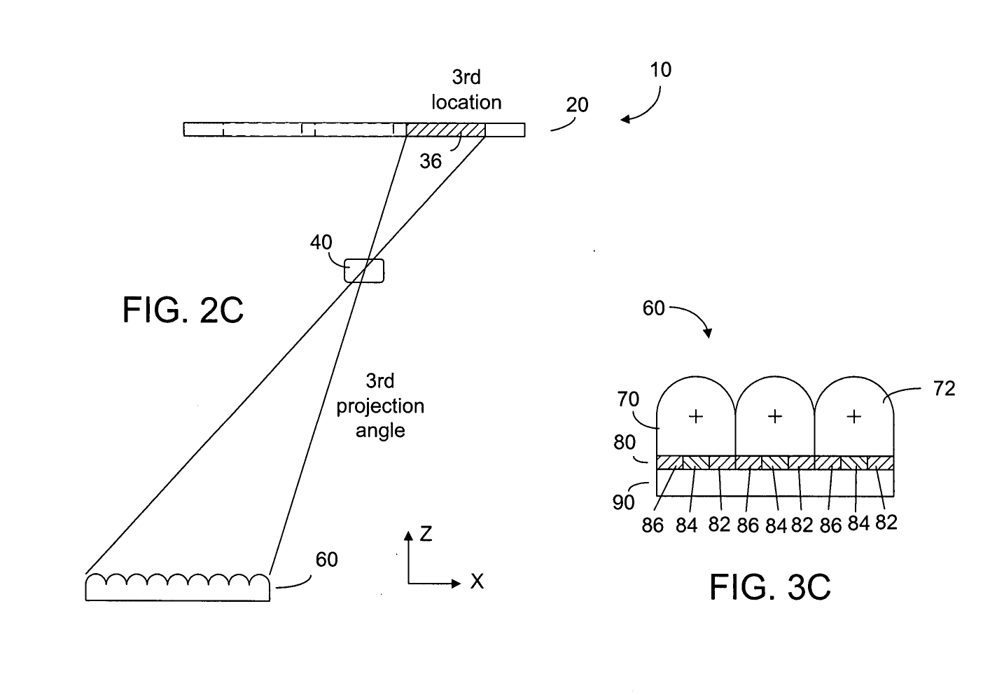

To disclose the present invention, a 3D photo composed from three views is used for illustrating the method and apparatus for composing a 3D photo. According to various embodiments of the present invention, an apparatus 10 is used to make a 3D photo. The apparatus 10 comprises a digital image display device 20, an optical image forming device 40 and a holder to hold a printer material 60, as shown in FIGS. 2A-2C. As shown in FIGS. 3A-3C, the print material 60 comprises a lenticular screen 70, a photosensitive emulsion 80 and a substrate or piece of paper 90 to support the emulsion 80. The lenticular screen 70 comprises a plurality of cylindrical lenses known as lenticules 72 for compressing a projected image into compressed images 82, 84, . . . . The digital display device 20 can be a liquid crystal display (LCD) panel, a light-emitting diode (LED) panel, a plasma display panel or any display panel configured to receive digital image data and display the digital image data as images at different display locations. The digital display device 20 is capable of displaying two or more images at a number of different display locations. The images can be displayed sequentially during the 3D photo composing process. If the images are displayed in non-overlapped locations, the display device can be arranged to simultaneously display those images at different locations.

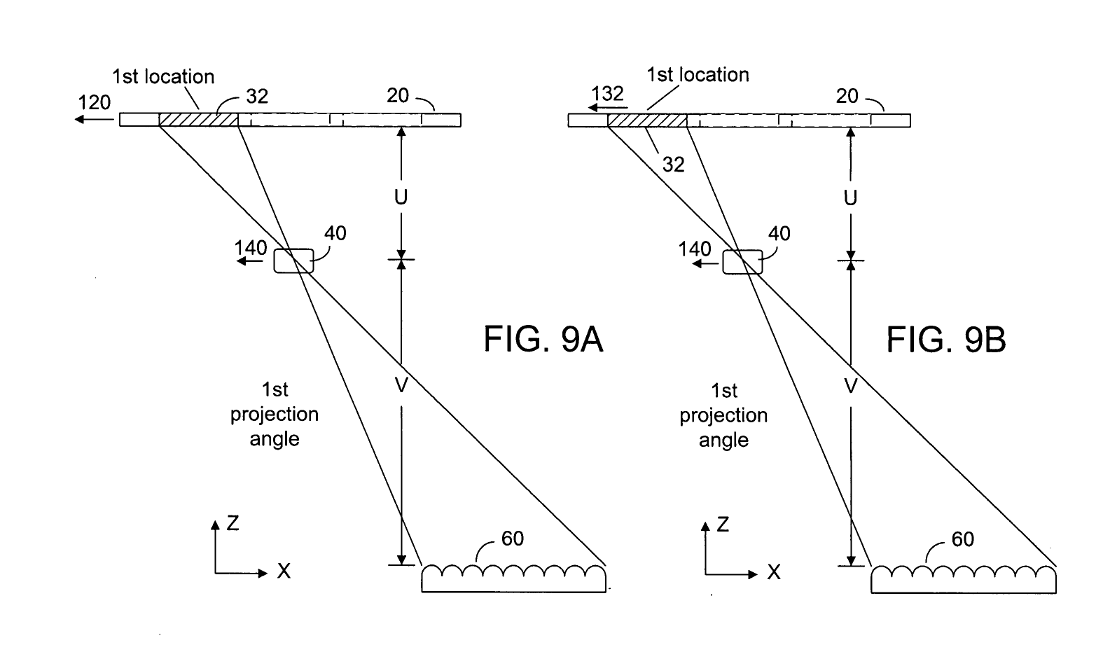

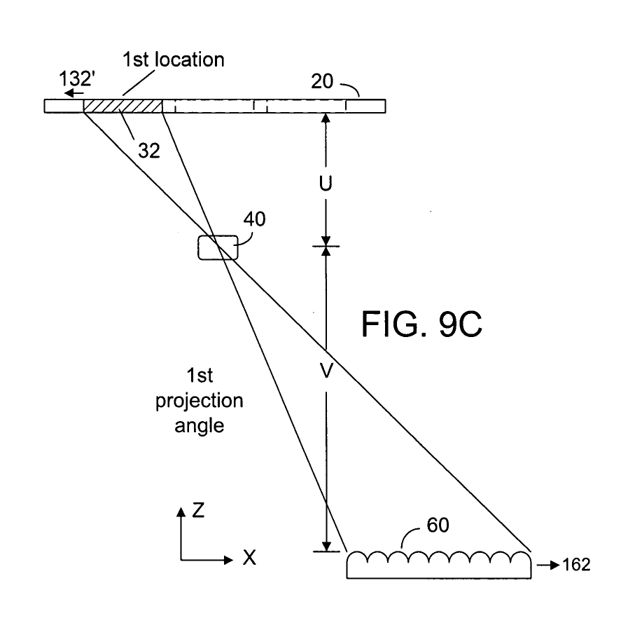

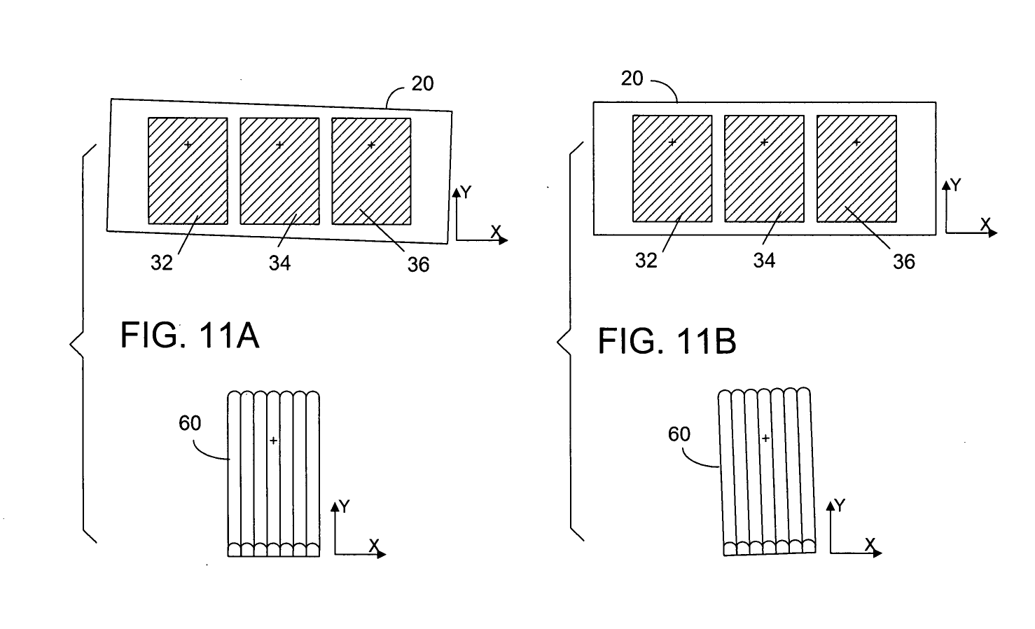

Throughout the disclosure, the display device 20 is described as being placed on a first plane, the print material 60 is placed on a third plane and the optical image forming device is located on a second plane between the first plane and the third plane (see FIG. 5). The first plane and the third plane are substantially parallel to each other and to an XY plane (see FIGS. 11A and 11B). Thus, the first plane and the third plane are also substantially perpendicular to the Z axis (see FIGS. 2A-2C). In some embodiments of the present invention, the optical image forming device is required to be moved laterally in a second plane, which is substantially parallel to the first plane (see FIGS. 5, 9A and 9B).

FIG. 2A shows the arrangement of the printing apparatus 10 when the first image 32 is displayed at the first location on the display device 20 in order to project the image through the optical image forming device 40 onto the print material 60 at a first projection angle. At the first projection angle, the projected image on the print material 60 is compressed into a plurality of compressed images 82 on the base the lenticules 72 of the lenticular screen 70, as shown in FIG. 3A. While keeping the display device 20 and the optical image forming device 40 stationary, the print material 60 is laterally shifted and the image 34 is displayed at a second location on the display device 20 so that the image 34 can be projected onto the print material 60 at a second projection angle, as shown in FIG. 2B. At this second projection angle, the projected image on the print material 60 is compressed into a plurality of compressed images 84 on the base the lenticules 72 of the lenticular screen 70, as shown in FIG. 3B. While keeping the display device 20 and the optical image forming device 40 stationary, the print material 60 is laterally shifted again and the image 36 is displayed at a third location on the display device 20 so that the image 36 can be projected onto the print material 60 at a third projection angle, as shown in FIG. 2C. At this third projection angle, the projected image on the print material 60 is compressed into a plurality of compressed images 86 on the base of the lenticules 72 of the lenticular screen 70, as shown in FIG. 3C.

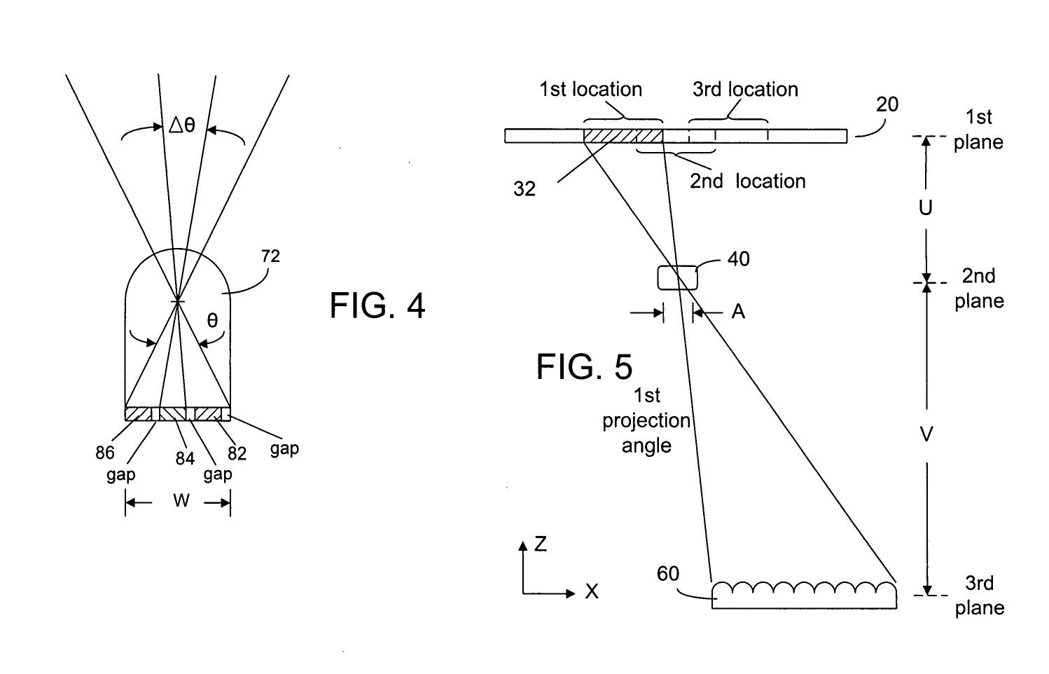

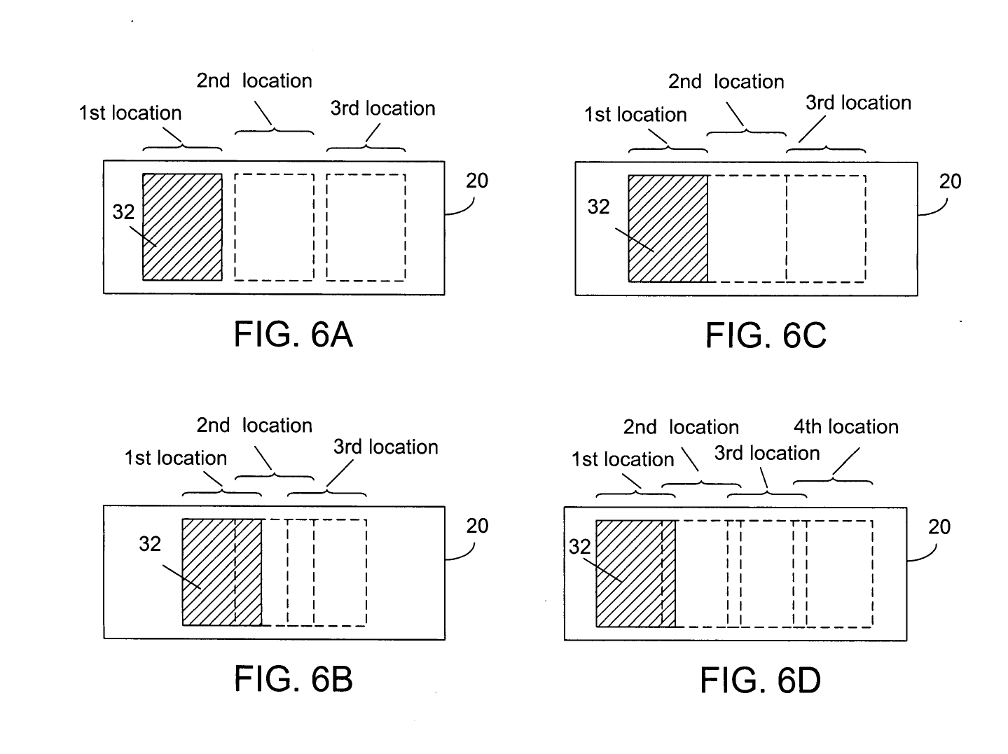

It should be noted that, depending on the angle θ of the lenticule as shown in FIG. 4, the compressed images 82, 84 and 86 may or may not be able to cover the entire base (W) of the lenticules 72. The width of the compressed images is determined by Δθ, which is determined by the aperture A of the optical image forming device 40 and the distance V, as shown in FIG. 5. The total lenticular angle θ of a lenticule is determined by the geometry of the lenticule. As shown in FIG. 5, the display device 20 is located on a first plane, the print material 60 is located on a third plane, which is substantially parallel to the first plane. The optical image forming device (or enlarging lens) 40 is located on a second plane between the first plane and the third plane. In order to project the images onto the print material 60 at different projection angles, the print material is shifted to different locations on the third plane. As shown in FIG. 5, U is the distance between the first plane and the second plane and V is the distance between the third plane and the second plane. Thus, the magnification of the projection is V/U and the optical image forming device 40 is effectively an enlarging lens. Depending on the total lenticular angle θ and the compression angle Δθ (FIG. 4), the aperture A of the optical image forming device 40 can be adjusted to suit the number of images to be projected onto the print material 60. Furthermore, depending upon the number of images to be projected and the aperture of the enlarging lens the total lenticular angle θ, the different locations on the display device 20 may be overlapped with each other (FIGS. 5, 6B) or separated from each other (FIGS. 2A-2C, 6A). In some cases, the different locations of the second image are adjacent to each other as shown in FIG. 6C. When three images are used to compose a 3D image, the three images can be images of a scene taken at three different angles, by one or more cameras or created graphics. However, the three images to be exposed onto the print material can be unrelated images or texts or graphic arts, or the combination thereof.

A 3D photo can be composed of the compressed images of more than three images. The number of images used in composing a 3D picture or photograph can range from two to 100 or more, depending on the resolution of the lenticules, for example. As shown in FIG. 6d, four images are displayed at four different locations on the display device 20 in order to achieve four different projection angles. In this case, all four images displayed at four different locations can be four different views. However, it is possible that the images displayed at the first and second locations are the same right view and the images displayed at the third and fourth locations are the same left view so as to compose a 3D photo as shown in FIG. 1.

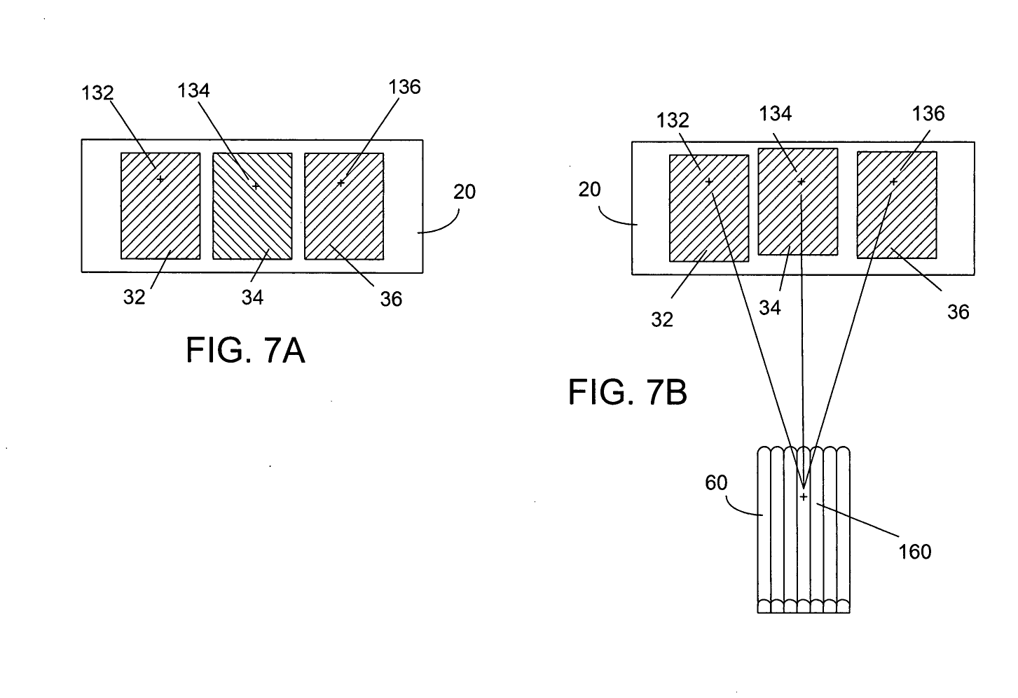

It should be noted that, when one views a 3D photo, some objects in the photo may appear in the plane of the photo, some objects may appear behind the plane of the photo and some in front of the plane of the photo. When composing a 3D photo, one of the objects that will appear on the plane of the photo is selected as the key subject. For example, when composing a 3D photo of a scene of a person located between some background and some foreground objects, the person may be selected as the key subject of the 3D photo. The key subjects in the images to be projected onto the print material must be aligned so that the projected images of the key subject will be located substantially at one point on the print material. This image alignment process is referred to as key-subject alignment. For example, three images 32, 34 and 36 are displayed sequentially or simultaneously at three different locations on the display device 20 in order to compose a 3D photo as shown in FIG. 7a. The key subjects 132, 134 and 136 in these three images may not be aligned such that the projected images of the key subject are located at the same point 160 on the print material 60 (FIG. 7B). In that case, it would be necessary to shift the displayed images for key subject alignment purposes. As shown in FIG. 7B, the displayed image 34 has been shifted upward and to the left and the displayed image 36 has been shifted upward for alignment purposes. According to one embodiment of the present invention, the shifting of the displayed images 34 and 36 from the locations as shown FIG. 7A to FIG. 7B can be carried out electronically, rather than mechanically. Thus, during the entire composition process, the display device 20 and the optical image forming device 40 can be kept stationary relative to each other and the key subject alignment process can be achieved by shifting one or more displayed images digitally or electronically.

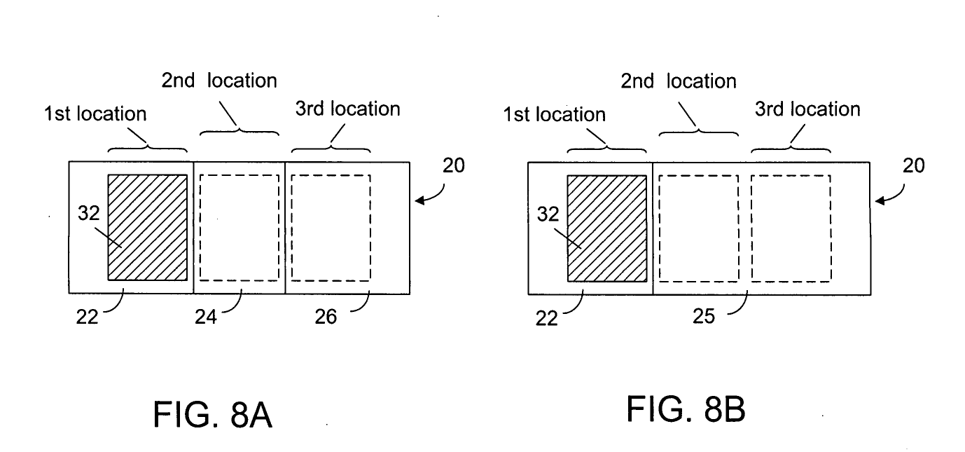

In one embodiment of the present invention, the display device 20 comprises a single display panel as shown in FIG. 6A. As such, the single display panel has sufficient display area to display two or more images at two different locations sequentially or simultaneously. In another embodiment of the present invention, the display device 20 comprises two or more display panels as shown in FIG. 8A. As shown in FIG. 8A, the display device 20 comprises three display panels 22, 24 and 26, each of which is used to display one image. In a different embodiment, the display device comprises two or more display panels, but one or more display panels can be used to display more than one image. As shown in FIG. 8B, while the display panel 22 is used to display one image at one the first location, the display panel 25 can be used to display images at the second and third locations.

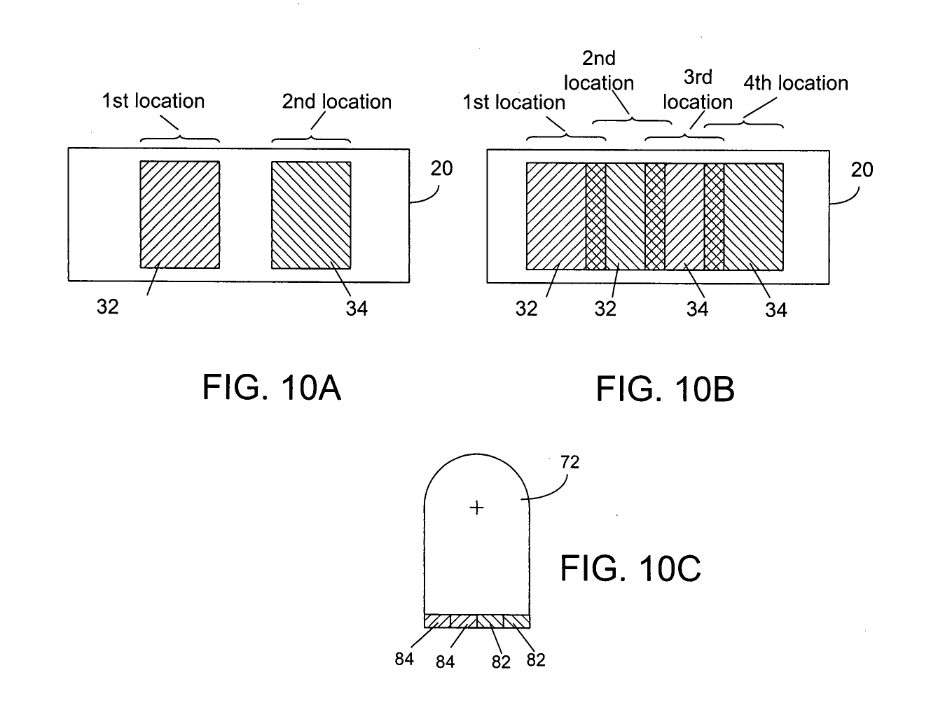

As shown in FIG. 4, the compressed images 82, 84 and 86 cannot fill the entire base of the lenticule 72, leaving some gaps or blanks in the 3D photo. This will affect the quality of the 3D photo. It may be possible to fill in the gaps by a number of ways. One is to widen the aperture of the optical image forming device. In one embodiment of the present invention, the aperture of the optical image forming device 40 is effectively widened by laterally shifting the optical image forming device 40 relative to the print material 60. As shown in FIG. 9A, the optical image forming device 40 is shifted by a distance 140 while the display device 20 is laterally shifted by a distance 120. The ratio of the distance 120 to the distance 140 is equal to (U+V)/V. The increase in Δθ is equal to the distance 140 divided by V. In a different embodiment of the present invention, instead of shifting the display device 20 by a distance 120, the displayed image 32 is electronically shifted by the distance 132 while the optical image forming device 40 is laterally shifted by a distance 140. As shown in FIG. 9B, the image shifting distance 132 is equal to the device shifting distance 120. As such, there is no need to mechanically move the display device 20 during the entire composing process. It is understood that one or more of the other displayed images may also be mechanically or electronically shifted along with the shifting of the optical image forming device 40 for gap filling purposes. In a different embodiment, instead of shifting the optical image forming device 40 by a distance 140, the print material 60 is shifted by a distance 162, which is equal to the distance 140 but in an opposition direction, as shown in FIG. 9C. Furthermore, the displayed image on the display device 20 is shifted by a distance 132′ which is substantially equal to the distance 132 minus the distance 140 (see FIG. 9B). As such, there is no need to mechanically move the optical image forming device 40. The gap-filling method, as shown in FIG. 9C, is, in principle, equivalent to the method as shown in FIG. 10B. It should be noted that, FIGS. 9A-9C illustrate various methods for filling the gap in the base of the lenticules when a first displayed image 32 is exposed onto the print material 60 (see FIG. 2A). These methods can also be used to fill the gap when a second displayed image 34 and a third displayed image 36 are exposed onto the print material 60 as shown in FIGS. 2B and 2C.

Another way to fill the gaps in a 3D photo is to increase the number, N, of images to be exposed such that N=θ/Δθ. For example, if two images 32 and 34 are used to compose a 3D photo (see FIG. 10A) but the two compressed images do not properly fill the entire base of the lenticules, it is possible to increase the number of the displayed images to four in order to increase the number of compressed images to four. In the embodiment as shown in FIG. 10B, the image 32 is repeatedly displayed at the first location and the second location and then the image 34 is repeatedly displayed at the third location and the fourth location. Now the aperture of the optical image forming device is adjusted so that N=Δθ=θ/4. As such, the display device 20 can be stationary relative to the optical image forming device 40 and only the print material is laterally shifted in order to change the projection angles (see FIGS. 2A-2C). FIG. 10C shows

It should be noted that, the digital display device 20 is generally composed of a two-dimensional arrays of pixels for displaying a digital image. The pixels are organized in columns and rows (not shown). For example, the rows are parallel to the Y axis and the columns are parallel to the X axis, as shown in FIG. 11B. It should also be noted that a lenticular screen is composed of a plurality of cylindrical lenses or lenticules. If the longitudinal axis of the cylindrical lenses is also parallel to the Y axis, then a Moire pattern may appear in the 3D photo. In order to reduce the Moire effect, it is possible to tilt the print material slightly so that the longitudinal axis of the lenticules is no longer parallel to the Y axis, as shown in FIG. 11B. In another embodiment of the present invention, in stead of tilting the print material 60, the display device 20 is slightly tilted, as shown in FIG. 11A.

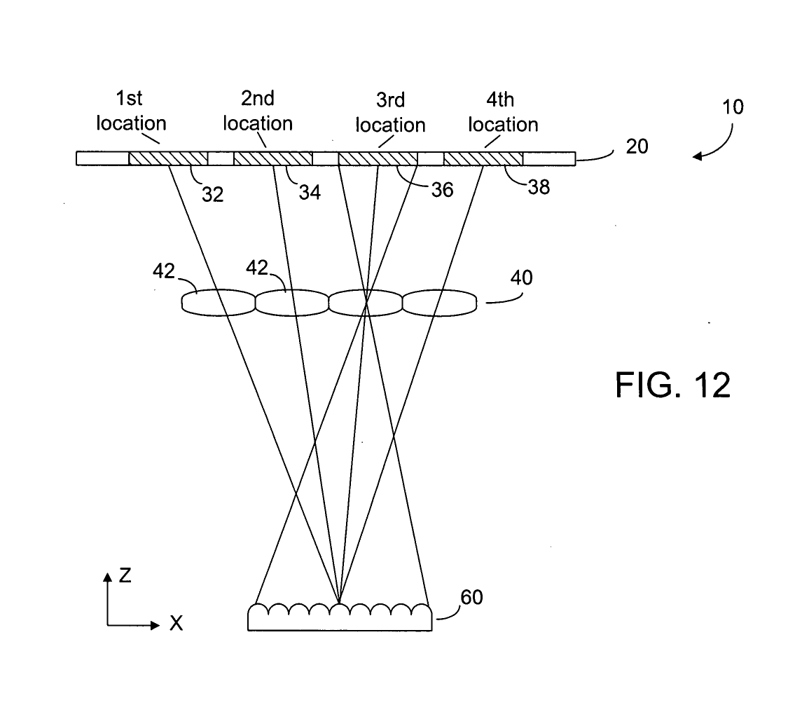

In a different embodiment of the present invention, as shown in FIG. 12, the optical image forming device 40 comprises a plurality of projection lenses or enlarging lenses 42. Each of the enlarging lenses 42 is fixedly located so that a plurality of images 32, 34, 36 and 38 can be exposed onto the print material 60 at different projection angles. In this embodiment, all the images can be simultaneously displayed on the display device 20. The print material 60 is kept stationary relative to the display device 20 and the optical image forming device 40 during the entire composition process. If the projection lenses 42 cannot be arranged such that the compressed images of images 32, 34, 36 and 38 cannot fill the entire lenticule base (see FIG. 4), it is possible to fill the gaps by electronically shifting the images 32, 34, 36 and 38 on the display device 20 and mechanically moving the print material 60 in opposite directions (see FIG. 9C).

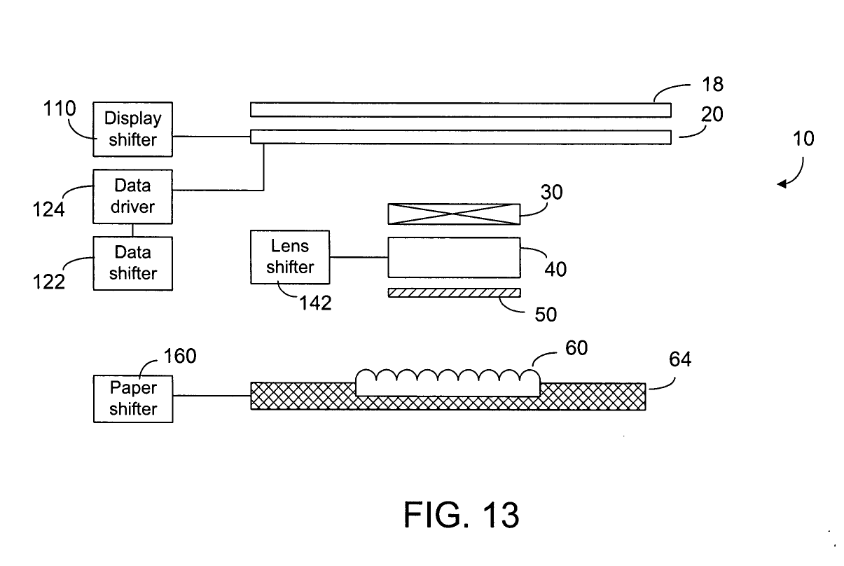

FIG. 13 shows an apparatus for making 3D photographs, according to one embodiment of the present invention. The apparatus 10 comprises a display device 20, which is configured to receive image data from a data driver 124. The data driver 124 is configured to receive location information from a data shifter 122 so that various images can be displayed at different locations on the display device. The display device 20 can be linked to a mechanical shifter 110 so that the display device 20 can be moved laterally on the first plane for gap filling purposes as illustrated in FIG. 9A. Likewise, the optical image forming device 40 is connected to a mechanical shifter 142 so that the optical image forming device 40 can be laterally shifted in the second plane for gap filling purposes as illustrated in FIGS. 9A and 9B. The apparatus 10 further comprises a holder 64 configured to hold a print material 60 on a third plane. The holder 64 is connected to a mechanical shifter 160 so that the print material 60 can be shifted to different locations as illustrated in FIGS. 2A-2C.

According to various embodiments of the present invention, the display device 20 can be a digital display device such as a liquid crystal display (LCD) panel or a light emitting diode (LED) panel. If the display device 20 comprises an LCD panel, a backlight unit 18 may be used to provide illumination to the LCD panel. Furthermore, a shutter 30 may be used to control the exposure of each projected image onto the print material 60, and a color filter pack 50 may be used to control the color of the images of the 3D photo.

As shown in FIG. 5, the display device 20 is located on a first plane, the enlarging lens, projection lens or optical image forming device 40 is located on a second plane, and the print material is located on a third plane. It should be noted that the shifting of the components on these three planes is relative. For example, in the printing method as shown FIGS. 2A-2C, it is possible to keep the display device 20 and the optical image forming device 40 stationary, while shifting the print material 60 on the third plane so that the displayed images can be exposed onto the print material at various projection angles. In this example, only the component on one plane is shifted. It is also possible to keep the print material 60 stationary, while shifting the display device 20 on the first plane together with the optical image forming device 40 on the second plane. In this example, the components on two planes are shifted.

In the gap-filling method as shown in FIG. 9A, it is possible to keep the display device 20 on the first stationary while shifting the optical image forming device 40 on the second plane and shifting the print material 60 on the third plane. It is also possible to keep the optical image forming device 40 on the second plane stationary while shifting the display device 20 on the first plane and shifting the print material 60 on the third plane. In the above-described two examples, the components on two planes are shifted. However, it is possible that the components on three planes are shifted.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method, comprising:
arranging a digital display device on a first plane;
arranging an optical image forming device on a second plane spaced from the first plane;
displaying a first image on the digital display device at a first location, such that a projection image of the first image is caused to form on a print material through the optical image forming device at a first projection angle, and
displaying a second image on the digital display device at a second location, such that a projection image of the second image is caused to form on the print material through the optical image forming device at a different second projection angle.

2. A method of claim 1, wherein the print material is located on a third plane spaced from the second plane and substantially parallel to the first plane, such that the second plane is located between the first plane and the third plane, said method further comprising:
shifting the print material on the third plane for changing the first projection angle to the second projection angle.

3. A method of claim 2, further comprising:
shifting the print material on the third plane for changing the second projection angle to a different third projection angle; and
displaying a third image on the digital display device at a third location, such that a projection image of the third image is caused to form on the print material through the optical image forming device at the third projection angle.

4. A method of claim 2, wherein the digital display device remains stationary relative to the optical image forming device.

5. A method of claim 1, wherein the optical image forming device comprises one or more lenses.

6. A method of claim 1, wherein the digital display device comprises a liquid crystal display.

7. A method of claim 1, wherein the digital display device comprises a light-emitting diode panel.

8. A method according to claim 1, wherein each of the first image and the second image comprises an alignment point, said method further comprising:
electronically shifting at least one of the first image and the second image on the digital display device such that the projection image of the first image and the projection image of the second image are aligned on the print material at the alignment point.

9. A method according to claim 2, wherein the print material comprises a plurality of lenticules, each of the lenticules having a lenticule base, and wherein the projection image of the first image is caused to form a first compressed image and the projection image of the second image is caused to form a second compressed image at the lenticular base, each of the first and second compressed images having an image width, said method further comprising:
adjusting the first projection angle for extending the image width of the first compressed image, and
adjusting the second projection angle for extending the image width of the second compressed image.

10. A method according to claim 9, wherein the print material is located at a first material position on the third plane when the projection image of the first image formed on the print material at the first projection angle, and the print material is located at a second material position on the third plane when the projection image of the second image is formed on the print material at the second projection angle, and wherein
said adjusting of the first projection angle comprises shifting the first image on the digital display device, and further shifting the print material on the third plane away from the first material location; and
said adjusting of the second projection angle comprises shifting the second image on the digital display device, and further shifting the print material on the third plane away from the second material location.

11. An apparatus, comprising:
a digital display device located on a first plane; and
an optical image forming device located on a second plane spaced from the first plane, wherein the digital display device is configured to display a plurality of images at a plurality of locations on the digital display device such that a projection image of each of said plurality of images is caused to form on a print material through the optical image forming device at a different projection angle.

12. An apparatus according to claim 11, further comprising:
a holder configured to hold the print material on a third plane spaced from the second plane and substantially parallel to the first plane such that the second plane is located between the first plane and the third plane.

13. An apparatus according to claim 12, further comprising:
a mechanical shifter arranged to shift the holder on the third plane for changing the projection angle.

14. An apparatus according to claim 13, wherein the digital display device is stationary relative to the optical image forming device.

15. An apparatus according to claim 11, wherein the digital display device comprises a liquid crystal display device.

16. An apparatus according to claim 11, further comprising:
a data driver configured to provide to the digital display device digital image data indicative of said plurality of images.

17. An apparatus according to claim 11, wherein said plurality of images comprise photographic images of a scene taken at different viewing angles.

18. An apparatus according to claim 11, wherein said plurality of images comprise one or more computer graphic images.

19. An apparatus according to claim 11, wherein said plurality of images comprise one or more text images.

20. An apparatus according to claim 11, wherein said digital display device comprises one or more display panels.
